(19) United States
(12) Patent Application Publication
(10) Pub. No.: US 2006/0032698 A1
(43) Pub. Date: Feb. 16, 2006

(54) Passive sound reflector

(76) Inventor: Neil M. Reck, Cincinnati, OH (US)

Correspondence Address: NEIL M. RECK, 500 NORWAY AVENUE, CINCINNATI, OH, 45229, US

(21) Appl. No.: 11/200,362

(22) Filed: Aug. 9, 2005

Related U.S. Application Data
(60) Provisional application No. 60/601,472, filed on Aug. 13, 2004.

(51) Int. Cl. G10K 11/00

(52) U.S. Cl. 181/175

(57) ABSTRACT

A passive acoustic reflector comprising of two flat side walls and one curved back wall of sound reflective material. The shape and acoustic reflection aids a musician in the ability to better hear themselves in practice and performance the way they sound to someone who is adjacent to their instrument. A passive acoustic reflector has wide applications as a device that allows sound to be returned to the musician.

This invention deals with the common problem of the placement of the sound holes of acoustic instruments, i.e. guitars, mandolins, ukuleles, tiples, etc. The sound holes face away from the players of these instruments and are a disadvantage to them not to hear what the instrument sounds like from the vantage of someone who is sitting adjacent to the sound holes.

The present invention is designed to redirect the outward sound waves back to the instrument's player. In doing so, the player has the advantage of hearing better audio subtleties and tones that would otherwise escape the ear.

The Figures are as follows:

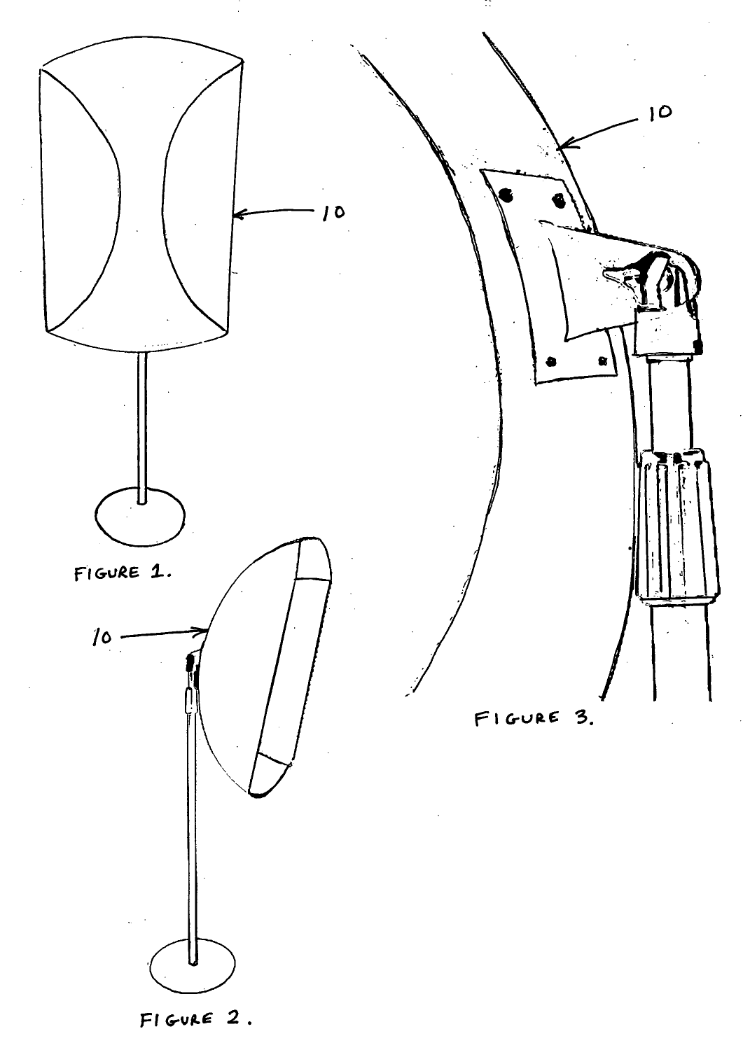

FIG. 1 is a front elevation illustration of one embodiment of the invention;

FIG. 2 is a quartering front elevation view of the invention;

FIG. 3 is a side view of a microphone stand adapted to support the invention.

The reflector 10 can be used with individual instruments, or to reflect an instrument's sound to a player playing individually or in a group.

What is claimed is:

1. A passive sound reflector comprising:
a pair of outwardly flared sidewalls, and having curved rear edges,
a rear wall confirming to said curved rear edges of said side walls, and
an open front side,
said reflector for reflecting acoustic sounds.

2. A microphone stand comprising:
a metal pipe within a metal pipe and a hand screw that adjusts the inner pipe at varying heights and a curved plate that attaches to the sound reflector.
